(19) United States
(12) Patent Application Publication
(10) Pub. No.: US 2008/0017667 A1
(43) Pub. Date: Jan. 24, 2008

(54) Fragrance delivery system using exothermic chemical reactions to volatilize aromatic materials and methods for making and using same

(76) Inventor: Anthony Valinotti, Freehold, NJ (US)

Correspondence Address: RICHARD R. MUCCINO, 758 SPRINGFIELD AVENUE, SUMMIT, NJ, 07901, US

(21) Appl. No.: 11/489,411

(22) Filed: Jul. 19, 2006

(51) Int. Cl. B67D 5/62

(52) U.S. Cl. 222/146.3

(57) ABSTRACT

This invention provides a fragrance delivery system having an air-impermeable receptacle containing inside a first air-permeable container comprising an exothermic composition, a second air-permeable container comprising an organoleptically effective amount of a fragrance agent, and an impermeable barrier connecting the first container with the second container. Opening of the air-impermeable receptacle causes air to activate the exothermic composition to produce heat, which volatilizes the fragrance agent. In another embodiment, the second container is a 2-sided container comprising an absorbent substrate attached to an impermeable barrier. The absorbent substrate comprises an organoleptically effective amount of a fragrance agent and the impermeable barrier is attached to the first container. In yet another embodiment, the fragrance delivery system is an air-impermeable container having inside a first air-permeable container comprising an exothermic composition and a second air-permeable container comprising an organoleptically effective amount of a fragrance agent. The second container is located above, and not in contact with, the first container.

### BACKGROUND OF THE INVENTION

1. Field of the Invention

This invention provides a fragrance delivery system having an air-impermeable receptacle containing inside a first air-permeable container comprising an exothermic composition, a second air-permeable container comprising an organoleptically effective amount of a fragrance agent, and an impermeable barrier connecting the first container with the second container. Opening of the air-impermeable receptacle causes air to activate the exothermic composition to produce heat, which volatilizes the fragrance agent. In another embodiment, the second container is a 2-sided container comprising an absorbent substrate attached to an impermeable barrier. The absorbent substrate comprises an organoleptically effective amount of a fragrance agent and the impermeable barrier is attached to the first container. In yet another embodiment, the fragrance delivery system is an air-impermeable container having inside a first air-permeable container comprising an exothermic composition and a second air-permeable container comprising an organoleptically effective amount of a fragrance agent. The second container is located above, and not in contact with, the first container.

2. Description of the Background

Many methods are known for delivering fragrances into the environment. Illustrative examples include candles, which use an open flame and a molten wax pool to deliver fragrance into the environment; potpourri, fragranced dried plant materials, which are left in an open container or sachet including simmering potpourris; spray, aerosol, and pump types; wall units, which use a fragrance oil which passes through a wick and is heated using electric power; lamp rings which are typically made of a porous material (such as a ceramic) containing a fragrance that sits above a light bulb; incense; diffusers, composed of “reeds” or “joss sticks”, which are placed in a fragrance oil and utilize wicking action to deliver fragrance, and battery operated units, which utilize a fan to move a fragrance agent through a room.

U.S. Pat. No. 6,635,077 (Grissmeyer et al.) discloses a structure comprising a film having a pair of opposed surfaces. The film is liquid impermeable and electrically charged and has a first and a second compartment separated from one another by a rupturable wall. First and second compositions are contained in the first and second compartments. The rupturable wall may be ruptured to permit mixing of the first and second compositions.

U.S. Pat. No. 5,046,479 (Usui) discloses a disposable body warmer comprising a flat bag having an air-permeable first surface having an air permeability per unit time of 5,000-10,000 sec/100 cc so as to bring about a reduction in the pressure accompanying oxidative heat generation of a heat generating agent packed in the flat bag. The heat-generating agent comprises iron powder mixed with 9-11% of a water-retaining agent, 18-22% of water, an oxidation promoter, and sodium chloride. The heat-generating agent is packed in a flat form having a thickness of 2-5 mm in the flat bag, and a nontransferable self-adhesive layer is attached to a second surface of the flat bag.

U.S. Pat. No. 4,756,299 (Podella) discloses a heating pad having a particulate chemical mixture, which is exothermically reactive in the presence of air. The heating pad has first and second opposed panels forming an envelope, which contains the mixture while admitting air. The first panel has a first body-contact surface and a first set of air-admitting perforations extending from the first body-contact surface to inside the envelope. The second panel has a second body-contact surface and a second set of air-admitting perforations extending from the second body-contact surface to inside the envelope. The second set of perforations differs structurally from the first set of perforations to provide different air-admission properties supporting differing reaction characteristics. Two different heat conditions may be applied to the human body by the two body-contact surfaces with the opposite body-contact surfaces exposed to the atmosphere.

U.S. Pat. No. 4,516,564 (Koiso et al.) discloses a heat generating body comprising a heat generating composition for generating heat upon contact with oxygen and a bag storing the heat generating composition. The bag comprises an air-permeable film with at least one hole having a diameter ranging between 0.05 and 50 mm. The bag further has a microporous film covering and closing the holes, the micro porous film having fine pores, each pore having a diameter equivalent ranging between 0.005 and 5 microns. The bag has an outer cover with air-impermeability covering the bag, the outer cover being adapted to be removed from the bag when used.

U.S. Pat. No. 4,338,098 (Yamaji) discloses a self-contained solid two-component heat-generating chemical system packaged in a form ready for use to generate heat in the form of heat of hydration of calcium oxide by allowing the two-components to contact each other. The first of the two-components comprises granules or powder of calcium oxide. The second of the two-components comprises granules or powder of a solid substance containing water of crystallization which substance supplies the water required for the hydration of calcium oxide exclusively of any externally supplied water. The package includes a partition physically separating the calcium oxide from the solid substance to maintain the calcium oxide and the solid substance out of contact with each other until the partition is removed just prior to use of the heat-generating chemical system.

U.S. Pat. No. 4,268,272 (Taura) discloses an exothermic composition for warming bags comprising mixing 20 to 25 parts by weight of an iron powder with a mixed fibrous and carbonaceous powder impregnated with a solution. The solution is prepared by dissolving a neutral salt in 8-15 parts by weight of an aqueous solution of a 0.05 to 1-normal alkali or alkaline weak acid salt.

U.S. Pat. No. 4,199,548 (Kaiho et al.) discloses a thermally diffusible composite comprising a thermally diffusible medicine for expelling or exterminating noxious organisms and a thermogenic composition as the heat source for the thermally diffusible medicine. The composite comprises at least one member selected from the group consisting of sulfides, polysulphides, and hydrosulphides of alkali metals, and hydrates thereof and at least one member selected from the group consisting of carbonaceous material, iron carbide, and activated clay.

U.S. Pat. No. 4,106,478 (Higashijima) discloses a packaged heat generator for warming objects. The heat generator comprises a heat generating material. The generator further comprises a first enclosing means of air-permeable material for containing the heat generating material. A second enclosing means of air impermeable material surrounds the first enclosing means, the second enclosing means having air passage means for allowing air to enter into the second enclosing means. Oxidation promotion material is within the second enclosing means and outside of the first enclosing means. A third enclosing means of air impermeable material surrounds the second enclosing means for removably containing the second enclosing means, the third enclosing means being openable at one end.

U.S. Pat. No. 4,106,477 (Feld) discloses a self contained multilayered heating pad structure comprising an inner heating source formed of a number of distributed liquid accessible heat producing cells spaced from each other to achieve uniform heating of the pad surface with enhanced heating pad flexibility for conformance to a body surface. An inner porous layer is formed of a liquid absorbent material located for surface wicking contact with the liquid accessible distributed heat cells to supply activating liquid. A flexible moisture and air permeable non-metallic sponge-like external layer is located and coupled to enable liquid to reach the heating cells through the external layer for activating the cells and for storage of liquid in the inner porous layer while providing a moist heat transfer path from the heating cells to an external surface of the external layer to form the moist heating pad structure.

U.S. Pat. No. 4,093,424 (Yoshida et al.) discloses a thermogenic composition comprising at least one compound selected from the group consisting of alkali metal sulfides, polysulfides, hydrosulfides, hydrates thereof and mixtures thereof, at least one compound selected from the group consisting of carbonaceous material, iron carbide, activated clay, iron, nickel and cobalt sulfates and potassium salt of anthraquinone sulfonate.

U.S. Pat. No. 3,301,250 (Glasser) discloses a flameless heater comprising a porous fabric bag permeable to oxygen. Disposed in the bag is a uniformly distributed mixture of vermiculite, iron particles, a highly dissociable inorganic salt, and an aqueous solution containing a wetting agent. Upon exposure of the bag to the atmosphere, the atmospheric oxygen passing through the bag reacts with the iron particles in the presence of the inorganic salt and the aqueous solution to produce heat.

U.S. Pat. No. 1,481,208 (Johnson) discloses a heating composition comprising iron oxide, sodium acetate, calcium chloride, muriate of ammonia, and odor preventing material, and a flexible water absorbent housing enclosing the ingredients.

U.S. Pat. No. RE 32,026 (Yamashita et al.) discloses a unified structure of a warmer and an airtight envelope, which is used to encapsulate the warmer at non-service time. The warmer comprises means for enclosing an exothermic composition in contact with water. The means comprises a two layered bag composed of an air-permeable cloth layer and an impermeable film layer having aeration holes with a predetermined total area and arranged one within the other. The enclosing means is disposed within the airtight envelope. The exothermic composition, which is activated on contact with air, comprises iron powder, active carbon and a reaction promoter selected from the group consisting of a chloride and a sulfate of a metal having an ionization tendency greater than iron. Upon opening of the airtight envelope, air contacts the exothermic composition and water to produce heat.

United States patent application no. 2005/0172951 (Yim) discloses a self-contained disposable single use heat generating apparatus. The apparatus comprises a heat generating pack having a first bag layer with a first surface area and a second bag layer having a second surface area, the second bag layer being fixed to the first bag layer, such that the first bag layer and the second bag layer define a number of pouches. A heat-generating agent is disposed in the pouches, the heat-generating agent arranged and configured to consume air at a predetermined air consumption rate in an exothermic reaction. At least one of the first surface area and the second surface area comprises an air permeable surface area having a predetermined airflow rate at which air is introduced to the beat generating agent. The predetermined airflow rate is arranged and configured to be less than the predetermined air consumption rate such that the beat generating agent remains substantially evenly distributed within the pouch.

Exothermic chemical reactions are disclosed in U.S. Pat. No. 6,915,798 (Minami), U.S. Pat. No. 6,890,553 (Sun. et al.), U.S. Pat. No. 6,886,553 (Yim), U.S. Pat. No. 6,752,998 (Verdrel-Lahaxe et al.), U.S. Pat. No. 6,623,657 (Berglund et al.), U.S. Pat. No. 6,264,681 (Usui), U.S. Pat. No. 5,993,854 (Needleman et al.), U.S. Pat. No. 5,879,378 (Usui), U.S. Pat. No. 5,809,573 (Bary), U.S. Pat. No. 5,483,949 (James), U.S. Pat. No. 5,443,056 (Smith et al.), U.S. Pat. No. 4,963,360 (Argaud), U.S. Pat. No. 4,767,800 (Neu et al.), U.S. Pat. No. 4,751,119 (Yukawa), U.S. Pat. No. 4,649,895 (Yasuki et al), U.S. Pat. No. 4,528,218 (Maione), U.S. Pat. No. 4,425,251 (Gancy), U.S. Pat. No. 4,400,285 (Gancy), U.S. Pat. No. 4,331,731 (Seike et al.), U.S. Pat. No. 4,282,005 (Sato et al.), U.S. Pat. No. 4,268,272 (Taura), U.S. Pat. No. 4,114,591 (Nakagawa), U.S. Pat. No. 4,067,313 (Donnelly), U.S. Pat. No. 3,976,049 (Yamashita et al.), and U.S. Pat. No. 3,874,504 (Verakas).

While the above disclosures provide examples of exothermic chemical reactions, none of the above disclosures suggest the use of an exothermic chemical reaction to volatilize a fragrance agent in a fragrance delivery system.

### SUMMARY OF THE INVENTION

The present invention provides a fragrance delivery system, which comprises an air-impermeable receptacle comprising inside:

(a) a first air-permeable container comprising an exothermic composition, which composition is activated on contact with air;

(b) a second air-permeable container comprising an organoleptically effective amount of a fragrance agent; and

(c) an impermeable barrier connecting the first container with the second container, which barrier prevents passage of the components from each container;

whereby opening of the air-impermeable receptacle causes air to activate the exothermic composition in the first container to produce heat, which volatilizes the fragrance agent in the second container.

The present invention also provides a fragrance delivery system, which comprises an air-impermeable receptacle comprising inside:

(a) a first air-permeable container comprising an exothermic composition, which composition is activated on contact with air; and

(b) a second 2-sided container comprising an absorbent substrate attached to an impermeable barrier, wherein the absorbent substrate comprises an organoleptically effective amount of a fragrance agent and the impermeable barrier is attached to the first container, which barrier prevents passage of the components from each container;

whereby opening of the air-impermeable receptacle causes air to activate the exothermic composition in the first container to produce heat, which volatilizes the fragrance agent in the second container.

The present invention further provides a fragrance delivery system, which comprises an air-impermeable container comprising inside:

(a) a first air-permeable container comprising an exothermic composition, which composition is activated on contact with air; and

(b) a second air-permeable container comprising an organoleptically effective amount of a fragrance agent, which container is located above, and not in contact with, the first container;

whereby opening of the air-impermeable container causes air to activate the exothermic composition in the first container to produce heat, which volatilizes the fragrance agent in the second container.

The present invention also provides a method for providing a fragrance comprising the steps of:

(A) providing a fragrance delivery system, which comprises an air-impermeable receptacle comprising inside:
(a) a first air-permeable container comprising an exothermic composition, which composition is activated on contact with air;
(b) a second air-permeable container comprising an organoleptically effective amount of a fragrance agent; and
(c) an impermeable barrier contacting the first container with the second container, which barrier prevents passage of the components from each container; and

(B) opening the air-impermeable receptacle to cause air to activate the exothermic composition in the first container to produce heat, which volatilizes the fragrance agent in the second container.

The present invention further provides a method for providing a fragrance comprising the steps of:

(A) providing a fragrance delivery system, which comprises an air-impermeable receptacle comprising inside:
(a) a first air-permeable container comprising an exothermic composition, which composition is activated on contact with air;
(b) a second air-permeable container comprising an organoleptically effective amount of a fragrance agent; and
(c) an impermeable barrier connecting the first container with the second container, which barrier prevents passage of the components from each container; and

(B) opening the air-impermeable receptacle to cause air to activate the exothermic composition in the first container to produce heat, which volatilizes the fragrance agent in the second container.

The present invention still further provides a method for providing a fragrance comprising the steps of:

(A) providing a fragrance delivery system, which comprises an air-impermeable container comprising inside:

(a) a first air-permeable container comprising an exothermic composition, which composition is activated on contact with air; and

(b) a second air-permeable container comprising an organoleptically effective amount of a fragrance agent, which second container is located above, and not in contact with, the first container; and

(B) opening the air-impermeable receptacle to cause air to activate the exothermic composition in the first container to produce heat, which volatilizes the fragrance agent in the second container.

### DETAILED DESCRIPTION OF THE INVENTION

The present invention provides a fragrance delivery system, which utilizes an exothermic chemical reaction to create heat and volatilize a fragrance agent into the environment. Applicants have discovered that the exothermic chemical reaction component (heating agent) and the fragrance agent component must be kept apart and not be allowed to interact. Interaction of the two components results in adverse effects on the heating profile of the heating agent and/or adverse effects on the fragrance profile of the fragrance agent. Nevertheless, the heating agent and the fragrance agent must be kept in close proximity to each other so that the heat from the heating agent can volatilize the fragrance agent. The present invention provides a fragrance delivery system having an air-impermeable receptacle containing a first air-permeable container comprising an exothermic composition and a second air-permeable container comprising an organoleptically effective amount of a fragrance agent. An impermeable barrier connects the first container with the second container. Opening of the air-impermeable receptacle causes air to activate the exothermic composition to produce heat, which volatilizes the fragrance agent. In another embodiment, the second container is a 2-sided container comprising an absorbent substrate attached to an impermeable barrier. The absorbent substrate contains an organoleptically effective amount of a fragrance agent and the impermeable barrier is attached to the first container with the heating agent. In yet another embodiment, the fragrance delivery system is an air-impermeable container having inside a first air-permeable container comprising an exothermic composition and a second air-permeable container comprising an organoleptically effective amount of a fragrance agent. The second container is located above, but not in contact with, the first container. The air-impermeable container may have a twist top lid having adjustable perforations to allow for the controlled introduction of air into the container.

As set out above, interaction of the heating agent component and the fragrance agent component results in adverse effects on the heating profile of the heating agent and/or adverse effects on the fragrance profile of the fragrance agent. In general, the fragrance agent will interfere with the exothermic reaction resulting in a loss of heat, which in turn will result in a loss of fragrance agent being volatilized. In addition, the presence of iron powder in the heating agent component will generally react with the fragrance agent (which is generally a mixture of compounds) leading to discoloration and a change in fragrance character. Furthermore, charcoal, a typical additive in heating agents, is known for its odor absorbing properties and will result in a loss of fragrance agent and/or a change of fragrance character. Maintaining the heating agent component and the fragrance agent component separate from each other allows these components to perform as intended and avoids adverse effects.

The term “accord”, as used herein, means a mixture of two or more fragrance raw materials, which are artfully combined to impart a pleasurable scent, odor, essence, or fragrance characteristic.

The terms “fragrance”, “fragrancing”, “fragrance agent”, and “perfume” as used herein, are used interchangeably whenever an organoleptic compound is referred to which is intended to stimulate the sense of smell.

The term “organoleptic”, as used herein, refers to compounds of the invention, which stimulate the sense of smell and are thus perceived as having a characteristic odor.

The term “organoleptically acceptable solvent”, as used herein, refers to solvents, which do not stimulate the sense of smell, and are thus perceived as not having a characteristic odor.

The term “organoleptically effective amount”, as used herein, means a level or amount of fragrance agent(s) present in a material at which the incorporated compound(s) exhibit(s) a sensory effect.

In accordance with the present invention, applicant has discovered a fragrance delivery system, which comprises an air-impermeable receptacle comprising inside (a) a first air-permeable container comprising an exothermic composition, which composition is activated on contact with air; (b) a second air-permeable container comprising an organoleptically effective amount of a fragrance agent; and (c) an impermeable barrier connecting the first container with the second container, which barrier prevents passage of the components from each container; whereby opening of the air-impermeable receptacle causes air to activate the exothermic composition in the first container to produce heat which volatilizes the fragrance agent in the second container.

The air-impermeable receptacle in the present invention may be selected from a wide variety of air-impermeable materials. Various films substantially impermeable to air, particularly to oxygen, can be used as the air-impermeable film. Examples of material of such films are: polyolefins such as polyethylene, polypropylene, polybutadiene or the like, synthetic resins such as polyvinyl chloride, polyvinylidene chloride, polyester, polyether, polysulfone, polynylon, polyamide, or the like. These films can be used alone or in the form of a laminated sheet in combination with a non-woven fabric. Alternatively, a non-woven fabric coated with such synthetic resins may be used as the air-impermeable receptacle. No specific selection is imposed on the selection of the kind of non-woven fabric.

The air-permeable container in the present invention may be selected from a wide variety of air-permeable materials. For example, the air-permeable materials can be made from a synthetic resin such as polyethylene, polypropylene, polyfluoroethylene or the like, and the pores may be formed chemically or physically during the manufacture or after the manufacture of the film. The following commercially available films are usable as the air-permeable material of the invention: Tyvek® (manufactured by E. I. Du Pont De Nemours & Co. Inc., USA), DuraGuard® (manufactured by DuraGuard Products, USA), FP-2 (manufactured by Asahi Chemical Industry Co., Ltd., Japan), Nop (Nippon Petrochemicals Co., Ltd., Japan), Nitoflon® NTF (manufactured by Nitto Electric Industrial Co., Ltd. Japan), NE Sheet® (manufactured by Tokuyama So& Co., Ltd., Japan), Cellpore® (manufactured by Sekisui Chemical Co., Ltd., Japan), Goretex® (manufactured by W. L. Gore & Associates, Inc., U.S.A.) and Polyflon® Paper (manufactured by Daikin Kogyo Co., Ltd., Japan). There is no substantial limitation in the air-permeability of the air-permeable material. Alternatively, the air-permeable material may be locally or partially coated by resin material such as natural resin, synthetic resin, or the like, and the air-permeable material portion can be defined by the non-coated portion.

The exothermic composition in the present invention, which is activated on contact with air, may be selected from a wide variety of heat generating compositions. Any heat generating composition, which is activated on contact with air, may be employed providing the heat generating composition does not produce an odor, or otherwise interfere with the fragrance profile of the fragrance agent. For example, the exothermic composition may be a composition, which involves the oxidation of a metal such as iron, aluminum, zinc, tin, or the like. Such compositions may be used alone or in a mixture and may contain optional additives such as an electrolyte, water, filaments, silica gel, zeolite, diatom earth, active carbon, and the like. Preferably, the heat generating composition contains iron as the main agent. A preferred heat-generating agent comprises iron powder as the main ingredient, water, a water retaining material (charcoal, vermiculite, or the like), an oxidation promoter, such as activated carbon, and salt. As an example, the heat-generating agent may comprise approximately 35-50% by weight of iron powder, 25-45% by weight of water, approximately 10-14% by weight of water retaining agent, and approximately 4.5-6% by weight of salt. Upon exposure to air, oxidation of the iron begins an exothermic reaction. In general, the exothermic composition may last from 1 to 12 hours reaching a maximum temperature of about 130° F. Preferably, the exothermic composition may last from about 1 to about 24 hours, more preferably from about 1 to about 15 hours, and more preferably from about 1 to about 8 hours. Preferably, the exothermic composition may reach a maximum temperature of from about 120° F. to about 180° F.

Fragrance-containing compositions are generally categorized into three types of fragrances based on their relative volatility; top, middle, and base notes. For the purposes of the present invention, “top note” fragrances are defined as fragrances having a high vapor pressure, and when applied to a paper sachet, vaporization takes place within 2 hours, and no scent remains. Top notes provide the initial impression of the perfume formulation. “Middle note” fragrances are defined as fragrances having a medium vapor pressure, and when applied to a paper sachet, the scent remains from about 2 to about 6 hours. Middle notes provide the skeleton of the perfume formulation. “Base note” fragrances are defined as fragrances having a low vapor pressure and high retentivity, and when applied to a paper sachet, the scent remains for more than about 6 hours. Base notes provide the characteristic of the perfume formulation. Top, middle, and base notes each serve a different purpose in the blending of fragrances and when properly formulated produce a “balanced fragrance” composition. The key to successfully formulating a fragrance-containing composition is the precise balance between these three groups of materials producing a fragrance-containing composition that diffuses during its evaporation in a manner, which has an aesthetic quality.

The fragrance agent in the present invention may be selected from a wide variety of fragrances. The highly volatile, low boiling, fragrance agent ingredients (top notes) typically have boiling points of about 250° C. or lower. The moderately volatile fragrance agent ingredients (middle notes) are those having boiling points of from about 250° C. to about 300° C. The less volatile, high boiling fragrance agent ingredients (base notes) are those having boiling points of about 300° C. or higher.

Examples of highly volatile, low boiling, fragrance agent ingredients are: anethole, benzaldehyde, benzyl acetate, benzyl alcohol, benzyl formate, iso-bornyl acetate, camphene, cis-citral (neral), citronellal, citronellol, citronellyl acetate, paracymene, decanal, dihydrolinalool, dihydromyrcenol, dimethyl phenyl carbinol, eucalyptol, geranial, geraniol, geranyl acetate, geranyl nitrile, cis-3-hexenyl acetate, hydroxycitronellal, d-limonene, linalool, linalool oxide, linalyl acetate, linalyl propionate, methyl anthranilate, alpha-methyl ionone, methyl nonyl acetaldehyde, methyl phenyl carbinyl acetate, laevo-menthyl acetate, menthone, iso-menthone, myrcene, myrcenyl acetate, myrcenol, nerol, neryl acetate, nonyl acetate, phenyl ethyl alcohol, alpha-pinene, beta-pinene, gamma-terpinene, alpha-terpineol, beta-terpineol, terpinyl acetate, and vertenex (para-tertiary-butyl cyclohexyl acetate). Some natural oils also contain large percentages of highly volatile fragrance agent ingredients. For example, lavandin contains as major components: linalool; linalyl acetate; geraniol; and citronellol. Lemon oil and orange terpenes both contain about 95% of d-limonene.

Examples of moderately volatile fragrance agent ingredients are: amyl cinnamic aldehyde, iso-amyl salicylate, beta-caryophyllene, cedrene, cinnamic alcohol, coumarin, dimethyl benzyl carbinyl acetate, ethyl vanillin, eugenol, iso-eugenol, flor acetate, heliotropine, 3-cis-hexenyl salicylate, hexyl salicylate, lilial (para-tertiarybutyl-alpha-methyl hydrocinnamic aldehyde), gamma-methyl ionone, nerolidol, patchouli alcohol, phenyl hexanol, beta-selinene, trichloromethyl phenyl carbinyl acetate, triethyl citrate, vanillin, and veratraldehyde. Cedarwood terpenes are composed mainly of alpha-cedrene, beta-cedrene, and other C₁₅H₂₄ sesquiterpenes.

Examples of less volatile, high boiling, fragrance agent ingredients are: benzophenone, benzyl salicylate, ethylene brassylate, galaxolide (1,3,4,6,7,8-hexahydro-4,6,6,7,8,8-hexamethyl-cyclopenta-gama-2-benzopyran), hexyl cinnamic aldehyde, lyral (4(4-hydroxy-4-methyl pentyl)-3-cyclohexene-10-carboxaldehyde), methyl cedrylone, methyl dihydro jasmonate, methyl-beta-naphthyl ketone, musk indanone, musk ketone, musk tibetene, and phenylethyl phenyl acetate.

The amount of the fragrance agent employed in the fragrance delivery system is an organoleptically effective amount to provide a fragrance agent that exhibits a sensory effect. The exact amount of fragrance agent used may vary depending upon the type of fragrance agent employed, the level of fragrance desired, and the type of exothermic composition employed. In general, the amount of fragrance agent present is the ordinary dosage required to obtain the desired result. Such dosages are known to the skilled practitioner in the fragrance arts and are not a part of the present invention. In a preferred embodiment, the fragrance agent in the fragrance delivery system is present in an amount of from about 0.5% to about 50%, preferably from about 1% to about 35%, more preferably from about 1% to about 20%, and most preferably from about 1% to about 10%, by total weight of the fragrance agent and exothermic composition.

The fragrance agent may further comprise an organoleptically acceptable solvent. The organoleptically acceptable solvent may be any solvent, which, does not interfere with the organoleptic properties of the fragrance agents of the present invention. In general, the organoleptically acceptable solvent does not stimulate the sense of smell and is not perceived as having a characteristic odor. Illustrative nonlimiting examples of organoleptically acceptable solvents may be selected from the group consisting of propylene glycol, ethanol, triacetin, glycerol, and vegetable oils. When employed, the organoleptically acceptable solvent will be present in an amount from about 1% to about 99%, preferably from about 5% to about 90%, and more preferably from about 20% to about 80%, by weight.

The impermeable barrier connecting the first container with the second container, which prevents passage of the components from each container, may be selected from a wide variety of impermeable/impervious barriers. Illustrative examples of impermeable barriers include metal foils such as aluminum, tin, and copper; and plastic barriers such as polyethylene and polypropylene.

The impermeable barrier connecting the first container with the second container may be connected by any means providing the means of connecting does not affect the impermeability of the barrier. A preferred means of connecting the first container with the second container via the impermeable barrier is by using a suitable adhesive.

The present invention further provides a fragrance delivery system, which comprises an air-impermeable receptacle comprising inside (a) a first air-permeable container comprising an exothermic composition, which composition is activated on contact with air; and (b) a second 2-sided container comprising an absorbent substrate attached to an impermeable barrier, wherein the absorbent substrate comprises an organoleptically effective amount of a fragrance agent and the impermeable barrier is attached to the first container, which barrier prevents passage of the components from each container; whereby opening of the air-impermeable receptacle causes air to activate the exothermic composition in the first container to produce heat which volatilizes the fragrance agent in the second container.

The second 2-sided container in this embodiment comprises an absorbent substrate attached to an impermeable barrier. Suitable impermeable barriers have been disclosed above. The absorbent substrate may be any substrate suitable to absorb/adsorb the organoleptically effective amount of a fragrance agent. The impermeable barrier attached to the absorbent substrate may be connected by any means providing the means of connecting does not affect the impermeability of the barrier. A preferred means of connecting the absorbent substrate to the impermeable barrier is by using a suitable adhesive. Preferably, the second 2-sided container is prepared by attaching aluminum foil to a paperboard (similar to the type used in automotive air fresheners) using a spray adhesive.

The present invention further provides a fragrance delivery system, which comprises an air-impermeable container comprising inside (a) a first air-permeable container comprising an exothermic composition, which composition is activated on contact with air; and (b) a second air-permeable container comprising an organoleptically effective amount of a fragrance agent, which container is located above, and not in contact with, the first container; whereby opening of the air-impermeable container causes air to activate the exothermic composition in the first container to produce heat which volatilizes the fragrance agent in the second container.

In this embodiment, the air-impermeable receptacle in the fragrance delivery system is an air-impermeable container. Containers are well known in the fragrance arts and can be of any shape and made of any non-flammable material. Generally a container is a metal (usually tin) container of a cylindrical shape to hold a candle and has a lid to protect the volatile components of the candle when not in use. The container may be designed to be air-impermeable or, more preferably, may be covered by an air-impermeable film, which films are described above for air-impermeable receptacles. The first air-permeable container comprising an exothermic composition is located on the bottom of the container and the second air-permeable container comprising an organoleptically effective amount of a fragrance agent is located above the first container but not in direct contact with the first container. When the air-impermeable container is opened, air will then activate the exothermic composition in the first container to produce heat, which volatilizes the fragrance agent in the second container. The air-impermeable container may be a candle tin having a twist top lid having adjustable perforations to allow for the controlled introduction of air into the container.

The present invention further provides a method for providing a fragrance comprising the steps of (A) providing a fragrance delivery system, which comprises an air-impermeable receptacle comprising inside (a) a first air-permeable container comprising an exothermic composition, which composition is activated on contact with air; (b) a second air-permeable container comprising an organoleptically effective amount of a fragrance agent; and (c) an impermeable barrier contacting the first container with the second container, which barrier prevents passage of the components from each container; and (B) opening the air-impermeable receptacle to cause air to activate the exothermic composition in the first container to produce heat which volatilizes the fragrance agent in the second container.

The present invention still further provides a method for providing a fragrance comprising the steps of (A) providing a fragrance delivery system, which comprises an air-impermeable receptacle comprising inside (a) a first air-permeable container comprising an exothermic composition, which composition is activated on contact with air; (b) a second air-permeable container comprising an organoleptically effective amount of a fragrance agent; and (c) an impermeable barrier connecting the first container with the second container, which barrier prevents passage of the components from each container; and (B) opening the air-impermeable receptacle to cause air to activate the exothermic composition in the first container to produce heat which volatilizes the fragrance agent in the second container.

The present invention yet further provides a method for providing a fragrance comprising the steps of (A) providing a fragrance delivery system, which comprises an air-impermeable container comprising inside (a) a first air-permeable container comprising an exothermic composition, which composition is activated on contact with air; and (b) a second air-permeable container comprising an organoleptically effective amount of a fragrance agent, which second container is located above, and not in contact with, the first container; and (B) opening the air-impermeable receptacle to cause air to activate the exothermic composition in the first container to produce heat which volatilizes the fragrance agent in the second container.

The final compositions are readily prepared using standard methods and apparatus generally known by those skilled in the fragrance arts. The apparatus useful in accordance with the present invention comprises mixing apparatus well known in the fragrance arts, and therefore the selection of the specific apparatus will be apparent to the artisan.

Throughout this application, various publications have been referenced. The disclosures in these publications are incorporated herein by reference in order to more fully describe the state of the art.

The present invention is further illustrated by the following examples, which are not intended to limit the effective scope of the claims. All parts and percentages in the examples and throughout the specification and claims are by weight of the final composition unless otherwise specified.

### EXAMPLES

### Examples 1-4

These examples illustrate the effects on the heating profiles of samples prepared by direct addition of 3 different fragrance agents to an exothermic composition in an organoleptically effective amount.

Three different fragrance agents (liquid mixtures) were added to individual packets of “HEATMAX® 12 hour body warmers”, at a rate of 1 g of fragrance agent oil per HEATMAX® unit. The fragrance agents tested were Fragrance Resources FR6358 (Example 1), Fragrance Resources FR3700 (Example 2), and Fragrance Resources FR3717 (Example 3). Example 4 was unfragranced and was used as a control. The examples are set out below.

| Example | Exothermic Composition | Fragrance Agent |
|---|---|---|
| 1 | HEATMAX ®* | FR6538** |
| 2 | HEATMAX ®* | FR3700** |
| 3 | HEATMAX ®* | FR3717** |
| 4 | HEATMAX ®* | none (control) |

*HEATMAX ® 12 hour body warmers
**A proprietary mixture of aromatic oils and essential oils (fragrance agents) of Fragrance Resources, Inc.

HEATMAX® 12 hour body warmers are soft paper-like pouches filled with a mixture of iron powder, water, salt, activated charcoal, and vermiculite. Exposure of the mixture to air activates an oxidation reaction with iron, which generates heat (exothermic composition).

The 3 fragrances tested contained a variety of chemical compounds that would be present in most fragrances or essential oils. The following list of chemical compounds and essential oils are representative of the compounds present in the 3 fragrance agents tested: phenols, animal extracts, amines, aldehydes, polycyclic musk, macrocyclic musk, nitro musk, ketones, Schiff's bases, alcohols, esters, essential oils, aromatic extracts and isolates, dyes and colors, fragrance mixtures, resins, and absolutes.

After addition of the 3 fragrance agents to the individual packets of “HEATMAX® 12 hour body warmers”, each packet was checked for heat generation at the 1 hour, 4 hour, 8 hour, and 12 hour time interval. At each test interval, the control (Example 4) performed as expected (generated heat) while the fragranced samples (Examples 1-3) remained at ambient temperature, and did not generate heat.

These examples show that direct addition of 3 different fragrance agents to an exothermic composition in an organoleptically effective amount adversely affects the heating profile of the exothermic composition.

### Example 5

This example illustrates the fragrance profile of a composition containing an exothermic composition and a fragrance agent present in an organoleptically non-effective amount.

Claim 3 of U.S. Pat. No. 1,481,208 recites a heat producing composition containing one teaspoon of powdered cloves mixed with 5 pounds of iron oxide along with additives. One teaspoon of powdered cloves weighs about 1.5 grams. A quantity of 1.5 grams of powdered cloves in 5 pounds of iron oxide results in a fragrance agent level in the total composition of approximately 0.066%. This level does not include the additional material employed (sodium acetate, calcium chloride, and muriate of ammonia), which would make the actual use level of the fragrance agent even lower. Fragrancing levels vary widely depending upon the fragrancing end product but generally are in the range of 1-50%).

A quantity of McCormick® Gourmet Collection ground cloves corresponding to a fragrance agent use level of approximately 0.066% was added to Grabber® Mycoal™ Hand Warmers 7+ hours (containing iron powder, water, cellulose, vermiculite, activated carbon, and salt). A panel of two experts performed an organoleptic analysis. The panel determined that the fragrance was either not detectable at close range, or barely detectable, and certainly not identifiable.

This example shows that there is no fragrance profile for a composition containing an exothermic composition and a fragrance agent present in an organoleptically non-effective amount.

### Examples 6-9

These examples illustrate the heat and fragrance profiles of 3 samples containing clove bud oil concentrate at various concentrations mixed directly with the Grabber® Mycoal™ Hand Warmers 7+ hours from Example 5.

Neat clove bud oil concentrate was mixed directly with the Grabber® Mycoal™ Hand Warmers 7+ hours from Example 5 at the 0% (control, Example 6), 0.1% (Example 7), 0.5% (Example 8), and 1% (Example 9) levels. Each packet was placed in a separate test room so that expert panelists could individually evaluate the heat generation as well as fragrance impact of each sample.

After 2 hours, the panel determined that the fragrance intensity of the sample containing the clove bud oil concentrate at the 0.1% level was not detectable, but that the fragrance intensity of the samples containing the clove bud oil concentrate at the 0.5% and 1% level was sufficient to be identified by the panelists. After 7 hours, the panel determined that the fragrance intensity of the sample containing the clove bud oil concentrate at the 0.1% level had no noticeable fragrance diffusion, even at close range, but that the fragrance intensity of the sample containing the clove bud oil concentrate at the 0.5% level was more intense, but still not strong enough to fragrance the room well, while the sample containing the clove bud oil concentrate at the 1% level was the most noticeable.

After 2 hours, the panel determined that the heat generation intensity of the sample containing the clove bud oil concentrate at the 0.1% level did not appear to adversely affect the heat generation intensity of that sample but that the samples containing the clove bud oil concentrate at the 0.5% and 1% levels did suffer a decrease in heat generation intensity compared to the unfragranced standard (control). Significantly, the unfragranced standard (control) was still very warm to the touch and the contents were free flowing while all of the fragranced samples (including the 0.1% level) were cool to the touch and the contents had caked into a mass.

Example 6 shows that there is no fragrance profile for a composition containing an exothermic composition and a fragrance agent present in an organoleptically non-effective amount. Examples 7 and 8 show that adding a fragrance agent in an organoleptically effective amount directly to an exothermic composition causes adverse reactions that result in loss of heat generation and caking of the final product.

### Examples 10-15

These examples illustrate the heating profiles of samples containing McCormick® Gourmet Collection ground cloves and clove bud oil concentrate at various concentrations mixed directly with the Grabber® Mycoal™ Hand Warmers 7+ hours from Example 5. The results are set out below.

Temperatures* of Samples over Time

| | | Initial | 30 | 3.5 | 5.5 | 6.5 |
|---|---|---|---|---|---|---|
| Example | Composition | time | minutes | hours | hours | hours |
| 10 | Standard (Control) | 96 | 125 | 101 | 87 | 75 |
| 11 | 0.01% McCormick ® | 102 | 120 | 99 | 83 | 78 |
| | ground cloves | | | | | |
| 12 | 2.5% McCormick ® | 106 | 120 | 99 | 83 | 78 |
| | ground cloves | | | | | |
| 13 | 5% McCormick ® | 110 | 111 | 100 | 87 | 84 |
| | ground cloves | | | | | |
| 14 | 0.1% Clove bud Oil | 91 | 100 | 91 | 85 | 93 |
| | Rectified | | | | | |
| 15 | 5% Clove bud Oil | 93 | 110 | 78 | 76 | 75 |
| | Rectified | | | | | |

*Temperatures are in degrees Fahrenheit. Measurements were taken using a Fisher Scientific Infrared Thermometer in average mode. 5 samplings were taken for each average temperature.

When the ground cloves were added to the exothermic composition (Grabber® Mycoal™ Hand Warmers 7+ hours from Example 5) at any dosage level (Examples 11-13), the product began to smoke indicating a chemical reaction was occurring between the fragrance agent and exothermic composition. Accordingly, none of these samples were deemed acceptable by the panel. Moreover, the sample at the 5% level (Example 13) adversely affected the heating profile of the composition.

When clove bud oil (a liquid fragrance) was added directly to the exothermic composition (Examples 14-15), the heating profile of the composition was adversely affected compared to the control Example 10.

Examples 11-13 show that direct mixing of an exothermic composition with a solid fragrance agent adversely affects the fragrance profile (smoking) of the final product. Examples 14-15 show that adding a liquid fragrance agent directly to an exothermic composition adversely affects the heating profile of the final product.

### Examples 16-19

These examples illustrate the heating profiles of samples containing an impermeable barrier, and a nitrocellulose strip, to separate the fragrance agent from the exothermic composition.

An impermeable barrier was prepared by attaching aluminum foil to a paperboard (similar to the type used in automotive air fresheners) using a spray adhesive. Two different fragrance agents (Examples 17 and 18) were applied to the paperboard side of the barrier at the 1 g level. The aluminum foil side was then attached to the heat source (Grabber® Mycoal™ Hand Warmers 7+ hours from Example 5) using a spray adhesive. Example 16 was the control and contained no fragrance agent. Example 19 contained the fragrance agent applied at the 0.05 g level to a nitrocellulose strip (similar to Listerine breath strip), which was then attached to the heat source using a spray adhesive. The results are set out below.

Temperatures** of Samples over Time

| | | | 30 | | | | | |
|---|---|---|---|---|---|---|---|---|
| Ex- | | Initial | min- | 1 | 3.5 | 5.5 | 6.5 | 7.5 |
| ample | Composition | time | utes | hour | hours | hours | hours | hours |
| 16 | Standard | 89 | 110 | 112 | 110 | 103 | 110 | 91 |
| | (control) | | | | | | | |
| 17 | FR6959*/foil | 91 | 115 | 108 | 112 | 112 | 113 | 92 |
| 18 | FR6976*/foil | 95 | 109 | 109 | 108 | 110 | 113 | 93 |
| 19 | FR6370*/ | 98 | 110 | 115 | 123 | 122 | 112 | 84 |
| | nitro- | | | | | | | |
| | cellulose | | | | | | | |
| | strip | | | | | | | |

*A proprietary mixture of aromatic oils and essential oils (fragrance agents) of Fragrance Resources, Inc.
**Temperatures are in degrees Fahrenheit.

The Table shows that the heat profiles of Examples 17 and 18 are similar to that of the standard (Example 16) showing the need to separate the fragrance material from the heat system with an impermeable barrier to avoid adversely affecting the heating profile of the product. Example 19 (fragranced nitrocellulose strip) performed well initially, but as the strip was heated, the fragrance agent was released and interacted with the exothermic composition adversely affecting the heat profile at the 3.5 and 5.5 hour mark.

### Examples 20-23

These examples illustrate a comparison of the fragrance profiles of fragrance agents in contact with an exothermic composition and the fragrance profiles of fragrance agents not in contact with an exothermic composition.

Four studies were carried out using 4 different fragrance agents; FR 5623-22, FR 6113-43, FR 5252-16, and FR 5606-23, proprietary mixtures of aromatic oils and essential oils (fragrance agents) of Fragrance Resources, Inc. The study compared the fragrance agents without a heat pack to fragrance agents attached to a heat pack, similar to Examples 17 and 18. Thus the fragrance agents attached to a heat pack employed an impermeable barrier prepared by attaching aluminum foil to a paperboard using a spray adhesive. The fragrance agents were applied to the paperboard side of the barrier at the 1 g level. The aluminum foil side was then attached to the heat source (Grabber® Mycoal™ Hand Warmers 7+ hours from Example 5) using a spray adhesive.

The samples were tested in four controlled booths for a 45 minute period by 5 expert panelists. Each panelist ranked the booths in order of strength; 1 being the strongest, 4 being the weakest. The results are set out below. In general, the % values given in the horizontal rows add up to 100% except in Example 21, wherein one or more panelists was unsure of the ranking.

### Example 20

(FR 5623-22)

| | % #1 | % #2 | % #3 | % #4 |
|---|---|---|---|---|
| With heat pack | 0 | 50 | 50 | 0 |
| Without heat pack | 16.5 | 0 | 0 | 83.5 |

### Example 21

(FR 6113-43)

| | % #1 | % #2 | % #3 | % #4 |
|---|---|---|---|---|
| With heat pack | 0 | 0 | 80 | 10 |
| Without heat pack | 0 | 0 | 10 | 80 |

### Example 22

(FR 5252-16)

| | % #1 | % #2 | % #3 | % #4 |
|---|---|---|---|---|
| With heat pack | 40 | 60 | 0 | 0 |
| Without heat pack | 0 | 0 | 20 | 80 |

### Example 23

(FR 5606-23)

| | % #1 | % #2 | % #3 | % #4 |
|---|---|---|---|---|
| With heat pack | 0 | 20 | 80 | 0 |
| Without heat pack | 0 | 0 | 20 | 80 |

Examples 20-33 show that in every case the fragrance profile of a fragrance agent in contact with an exothermic composition was superior to that of the fragrance profile of a fragrance agent not in contact with an exothermic composition.

The invention being thus described, it will be obvious that the same may be varied in many ways. Such variations are not to be regarded as a departure from the spirit and scope of the invention and all such modifications are intended to be included within the scope of the following claims.

We claim:

1. A fragrance delivery system, which comprises an air-impermeable receptacle comprising inside:
(a) a first air-permeable container comprising an exothermic composition, which composition is activated on contact with air;
(b) a second air-permeable container comprising an organoleptically effective amount of a fragrance agent; and
(c) an impermeable barrier connecting the first container with the second container, which barrier prevents passage of the components from each container;
whereby opening of the air-impermeable receptacle causes air to activate the exothermic composition in the first container to produce heat, which volatilizes the fragrance agent in the second container.

2. The fragrance delivery system according to claim 1, wherein the exothermic composition is a mixture of iron powder, water, salt, activated charcoal, and vermiculite.

3. The fragrance delivery system according to claim 1, wherein the fragrance agent is present in an amount of from about 0.5% to about 50%, by total weight of the fragrance agent and exothermic composition.

4. The fragrance delivery system according to claim 3, wherein the fragrance agent is present in an amount of from about 1% to about 35%, by total weight of the fragrance agent and exothermic composition.

5. The fragrance delivery system according to claim 1, wherein the impermeable barrier is selected from the group consisting of aluminum, tin, and copper foils; and polyethylene and polypropylene barriers.

6. A fragrance delivery system, which comprises an air-impermeable receptacle comprising inside:
(a) a first air-permeable container comprising an exothermic composition, which composition is activated on contact with air; and
(b) a second 2-sided container comprising an absorbent substrate attached to an impermeable barrier, wherein the absorbent substrate comprises an organoleptically effective amount of a fragrance agent and the impermeable barrier is attached to the first container, which barrier prevents passage of the components from each container;
whereby opening of the air-impermeable receptacle causes air to activate the exothermic composition in the first container to produce heat, which volatilizes the fragrance agent in the second container.

7. The fragrance delivery system according to claim 6, wherein the exothermic composition is a mixture of iron powder, water, salt, activated charcoal, and vermiculite.

8. The fragrance delivery system according to claim 6, wherein the fragrance agent is present in an amount of from about 0.5% to about 50%, by total weight of the fragrance agent and exothermic composition.

9. The fragrance delivery system according to claim 8, wherein the fragrance agent is present in an amount of from about 1% to about 35%, by total weight of the fragrance agent and exothermic composition.

10. The fragrance delivery system according to claim 6, wherein the impermeable barrier is selected from the group consisting of aluminum, tin, and copper foils; and polyethylene and polypropylene barriers.

11. A fragrance delivery system, which comprises an air-impermeable container comprising inside:
(a) a first air-permeable container comprising an exothermic composition, which composition is activated on contact with air; and
(b) a second air-permeable container comprising an organoleptically effective amount of a fragrance agent, which container is located above, and not in contact with, the first container;
whereby opening of the air-impermeable container causes air to activate the exothermic composition in the first container to produce heat, which volatilizes the fragrance agent in the second container.

12. The fragrance delivery system according to claim 11, wherein the exothermic composition is a mixture of iron powder, water, salt, activated charcoal, and vermiculite.

13. The fragrance delivery system according to claim 11, wherein the fragrance agent is present in an amount of from about 0.5% to about 50%, by total weight of the fragrance agent and exothermic composition.

14. The fragrance delivery system according to claim 13, wherein the fragrance agent is present in an amount of from about 1% to about 35%, by total weight of the fragrance agent and exothermic composition.

15. The fragrance delivery system according to claim 11, wherein the air-impermeable container comprises a twist top lid having adjustable perforations to allow for the controlled introduction of air into the container.

16. A method for providing a fragrance comprising the steps of:
(A) providing a fragrance delivery system, which comprises an air-impermeable receptacle comprising inside:
(a) a first air-permeable container comprising an exothermic composition, which composition is activated on contact with air;
(b) a second air-permeable container comprising an organoleptically effective amount of a fragrance agent; and
(c) an impermeable barrier contacting the first container with the second container, which barrier prevents passage of the components from each container; and
(B) opening the air-impermeable receptacle to cause air to activate the exothermic composition in the first container to produce heat, which volatilizes the fragrance agent in the second container.

17. The method according to claim 16, wherein the fragrance agent is present in an amount of from about 0.5% to about 50%, by total weight of the fragrance agent and exothermic composition.

18. A method for providing a fragrance comprising the steps of:
(A) providing a fragrance delivery system, which comprises an air-impermeable receptacle comprising inside:
(a) a first air-permeable container comprising an exothermic composition, which composition is activated on contact with air;
(b) a second air-permeable container comprising an organoleptically effective amount of a fragrance agent; and
(c) an impermeable barrier connecting the first container with the second container, which barrier prevents passage of the components from each container; and
(B) opening the air-impermeable receptacle to cause air to activate the exothermic composition in the first container to produce heat, which volatilizes the fragrance agent in the second container.

19. The method according to claim 18, wherein the fragrance agent is present in an amount of from about 0.5% to about 50%, by total weight of the fragrance agent and exothermic composition.

20. A method for providing a fragrance comprising the steps of:
(A) providing a fragrance delivery system, which comprises an air-impermeable container comprising inside:
(a) a first air-permeable container comprising an exothermic composition, which composition is activated on contact with air; and
(b) a second air-permeable container comprising an organoleptically effective amount of a fragrance agent, which second container is located above, and not in contact with, the first container; and
(B) opening the air-impermeable receptacle to cause air to activate the exothermic composition in the first container to produce heat, which volatilizes the fragrance agent in the second container.

21. The method according to claim 20, wherein the fragrance agent is present in an amount of from about 0.5% to about 50%, by total weight of the fragrance agent and exothermic composition.
